(19) United States
(12) Patent Application Publication
(10) Pub. No.: US 2006/0003702 A1
(43) Pub. Date: Jan. 5, 2006

(54) Communications device and wireless communications system

(75) Inventors: Keiji Nibe, Yokohama (JP); Takurou Nishikawa, Yokohama (JP)

Correspondence Address: Edward A. Pennington;Swidler Berlin LLP, Suite 300, 3000 K Street, N. W., Washington, DC, 20007, US

(73) Assignee: Fujitsu Limited

(21) Appl. No.: 11/078,523

(22) Filed: Mar. 14, 2005

(30) Foreign Application Priority Data
Jul. 2, 2004 (JP) 2004-197009

(51) Int. Cl. H04B 17/00

(52) U.S. Cl. 455/67.11

(57) ABSTRACT

Transmissions are made controllable, taking into consideration the effects of the channels that can be transmitted on in a burst state. A communications device for transmitting adaptive modulation control parameters for communication devices that control adaptive modulation, comprises a measuring device operable to measure the reception environment and a parameter generator operable to generate the adaptive modulation control parameters based on measurement results of the reception environment and on a reception status of a predefined channel within a period of the measurement of the reception environment.

### CROSS REFERENCE TO RELATED APPLICATION

This application is related to and claims priority to Japanese Application No. 2004-197009 filed Jul. 2, 2004 in the Japanese Patent Office, the contents of which are incorporated by reference herein.

### BACKGROUND OF THE INVENTION

1. Field of the Invention

The present invention relates to wireless communications systems and communications devices, an in particular, it relates to a mobile wireless communications system, using the W-CDMA (UMTS) communication format, and a mobile station and wireless base station used in said system.

2. Description of the Related Art

Currently, the standardization of the W-CDMA (UMTS) format is advancing as one of the formats of the third generation mobile communication systems, 3rd Generation Partnership Project (3GPP). In addition, the High Speed Downlink Packet Access (HSDPA) is regulated to provide a maximum downlink transmission rate of about 14 Mbps as one of the subjects of the standardization.

HSDPA utilizes an adaptive modulation and coding (AMC) scheme. For example, the modulation scheme is switched between the QPSK modulation and 16 QAM modulation based on the radio environment between the base and mobile stations.

In addition, HSDPA utilizes the Hybrid Automatic Repeat reQuest (H-ARQ) system. In the case of H-ARQ, if the mobile station detects an error in the data received from the base station, the mobile station sends a request for retransmission to the base station and the base station retransmits the data. The mobile station utilizes both the already received data and the retransmitted receiving data and performs error-collection decoding. The H-ARQ controls the number of retransmissions by using both the already received data and the retransmitted receiving data.

The main wireless channels utilized by HSDPA include: High-Speed Shared Control Channel (HS-SCCH), High-Speed Physical Downlink Shared Channel (HS-PDSCH), and High-Speed Dedicated Physical Control Channel (HS-DPCCH).

Both HS-SCCH and HS-PDSCH are shared downlink channels (in other words, in the direction from the base station to the mobile station) and HS-SCCH is the control channel to transmit the various parameters related to transmission data transmitted via HS-PDSCH. Examples of various parameters include, for example: information of modulation type indicating which modulation scheme is to be used for transmission of data via HS-PDSCH and number of spreading codes (codes number) allocated to the transmission of the data via HS-PDSCH and information of rate matching processing patterns used for the transmission of the data via HS-PDSCH.

On the other hand, HS-DPCCH is the dedicated uplink control channel from the mobile station to the base station. The HS-DPCCH is utilized when the mobile station transmits ACK and NACK signals to the base station in response to whether or not the data can be received via the HS-PDSCH. Furthermore, the NACK signal is transmitted from the mobile station when the mobile station fails to receive the data (when the received data has a CRC error, etc.) and the base station executes the retransmission controls.

HS-DPCCH is utilized to periodically transmit the measurement results of the receiving signal reception quality (e.g., SIR) from the mobile station as CQI (Channel Quality Indicator) to the base station. The base station determines the quality of the downlink radio environment according to the received CQI. If the radio environment is favorable, the base station changes modulation scheme to a modulation scheme that enables high-speed data transmission. If the wireless environment is not favorable, the modulation scheme is changed to a modulation scheme that enables low-speed data transmission.

Channel Configuration

The explanation of the HSDPA channel configuration is as follows:

FIG. 1 is a diagram showing HSDPA's channel configurations. Furthermore, each channel is separated by codes because W-CDMA utilizes the code division multiple access method.

Firstly, the as yet unexplained channels will be simply explained.

CPICH (Common Pilot Channel) and P-CCPCH (Primary Common Control Physical Channel) are common downlink channels.

CPICH is a channel utilized by the mobile station for the timing standard for other downlink physical channels in a cell, for channel estimations, for cell searches. CPICH is a channel used for transmitting so called pilot signals. There is one P-CCPCH for each cell and it is a channel that can be used to transmit broadcasting information.

Explanation of each channel's timing is as follows, using FIG. 1.

As shown in the diagram, each channel is configured with 15 slots (each slot corresponds to 2560 chip lengths) for one frame (10 ms). As explained above, since CPICH is utilized as the standard for other channels, the start of CPICH's frame matches with the starts of P-CCPCH and HS-SCCH's frames. The start of HS-PDSCH's frame is delayed by 2 slots when compared to HS-SCCH, etc., however, after the mobile station receives the modulation type information through HS-SCCH, HS-PDSCH can be demodulated with the demodulation method corresponding to the received modulation type. In addition, HS-SCCH and HS-PDSCH configure 3 slots for 1 subframe.

HS-DPCCH is an uplink channel and utilized to transmit the ACK/NACK response signals, used to confirm receipt from the mobile station to the base station after a lapse of about 7.5 slots after HS-PDSCH is received. In addition, the second and third slots are utilized for periodic feedback transmissions of CQI information for adaptive modulation from the mobile station to the base station. The CQI information transmitted to the base station is calculated by the mobile station based on the reception environment (i.e. SIR of CPICH) during the period from before the 4th slot to before the 1st slot of CQI transmission.

FIG. 2 shows the CQI table in case that the SIR (Signal to Interference Ratio) of CPICH is used for determination of CQI.

As shown in the diagram, the table defines the number of TBS (Transport Block Size) bits, code number, modulation type, and CPICH-SIR for each of CQI information 1-30.

The number of TBS bits indicate to the number bits transmitted within 1 subframe, the code number indicates the spreading code number utilized for HS-PDSCH transmission, and modulation type indicates whether either QPSK or QAM is utilized.

As is clear from the diagram, it is known that the more SIR (large SIR) of CPICH is favorable, the value of CQI also increases. The larger the value of CQI, the more corresponding numbers of TBS bits and spreading code also increase and the modulation method also switches to the QAM modulation method, and, as a result, the more SIR is favorable, the faster the transmission speed becomes.

The table shown in the diagram, for example, is stored in the memory in the mobile station. As was explained previously for the mobile station, the SIR of CPICH is measured during the measurement period of the reception environment, the CQI corresponding to the SIR measured with reference to the recorded table is specified, and transmission of the specified CQI to the base station is made.

Since the base station performs the adaptive modulation and coding as previously explained, according to the received CQI information, transmission can be controlled, taking into consideration the receiving environment of CPICH at the mobile station.

The above was a simple explanation of HSDPA's channel configuration.

The items stated above related to HSDPA are disclosed for example in the following 3rd Generation Partnership Project: Technical Specification Group Radio Access Network; Multiplexing and channel coding (FDD) (3G TS 25.212).

According to the previously explained background art, the mobile station (reception device) measures the receiving environment, and by reporting the results to the base station (transmitting device), the transmitting device can control the adaptive modulation in response to the receiving environment.

However, as can be understood by referring to FIG. 1, the channel that can transmit signals at high speed (HS-PDSCH) also simultaneously transmits within the reception environment measurement period (SIR measurement period).

Ordinarily, if the transmission of this sort of high-speed signal is carried out continuously, large differences in the receiving environment during periodic measurement periods and the receiving environment during transmission period when the high speed signal is transmitted to the reception device according to the reported receiving environment information, would be minimal. However, if the transmission of the high speed signal is in a burst state (existing both during transmission and non-transmission periods), there may be large differences between the measurements of the reception environment during a period when the high speed signal is not transmitted and the reception environment afterwards, when the high speed signal is actually transmitted to the reception device. This is because the effect of the multi-pass, etc., may interfere with the signal itself, transmitted to its reception device.

Accordingly, a need arises to make transmissions controllable, taking into consideration the effects of the channels on which transmissions are made in a burst state.

### SUMMARY OF THE INVENTION

Accordingly, one of the purposes of this invention is to make transmissions controllable, taking into consideration the effects of the channels on which transmissions are made in a burst state.

Furthermore, not restricted to the above-mentioned purpose, it can also be proposed that one of the purposes of this invention is to attain results not available to conventional technology as the result of the various configurations indicated as the best to implement the invention described hereinafter.

In one embodiment of the present invention, a communications device for transmitting parameters used for adaptive modulation control to a transmitting device that execute adaptive modulation control, comprises a measuring device operable to measure the reception environment and a parameter generator operable to generate the parameters based on measurement results of the reception environment and on a reception status of a predefined channel within a period of the measurement of the reception environment.

Preferably the parameters is set as different parameters for same measured reception environment according to the reception status, wherein the transmission rate corresponding to the parameters for the reception status indicating that the predetermined channel is transmitted at least to the communication device is lower than the transmission rate corresponding to the parameters for the reception status indicating that the predetermined channel is not transmitted to any of communication devices.

The parameter generator is further operable to reflect in the parameters generated when the predefined channel is not transmitted to any of the mobile stations the measurement results when the predefined channel is at least transmitted to the communications device within the measurement period.

The measuring part is further operable to divide the measurement period into a first measurement period and a second measurement period and the parameter generator combine weighted measurement results from both periods to form the measurement result.

The reception status of the predefined channel is determined according to whether or not the predefined channel was transmitted to the communications device within the measurement period.

The reception status of the predefined channel is determined based on whether or not a non-transmission period of the predefined channel is assumed to be included within the measurement period.

The assumption of whether or not a non-transmission period of the predefined channel is included within the measurement period is determined based on a total reception level or a total received power.

In one embodiment of the present invention, a mobile station used in a mobile communications system compatible with HSDPA comprises a CQI information generator operable to generate CQI information to be transmitted to a base station based on an HS-PDSCH reception status during a CPICH reception quality measurement period.

The mobile station further comprises a transmission rate generator operable to generate a transmission rate based on the generated CQI information, wherein the transmission rate generated when the HS-PDSCH is not transmitted to any of the mobile stations is a lower transmission rate than the transmission rate generated when the HS-PDSCH is at least transmitted to the mobile station within the CPICH reception quality measurement period.

The CQI information generator is further operable to reflect in the CQI information generated when the HS-PDSCH channel is not transmitted to any of the mobile stations the measurement results when the HS-PDSCH channel is at least transmitted to the mobile station within the CPICH reception quality measurement period.

The mobile station further comprises a measuring part operable to divide the CPICH reception quality measurement period into a first measurement period and a second measurement period and to combine weighted measurement results from both periods to form the CPICH reception quality measurement result.

The HS-PDSCH reception status is determined according to whether or not the HS-PDSCH channel was transmitted to the mobile station within the measurement period.

The HS-PDSCH reception status is determined based on whether or not a non-transmission period of the HS-PDSCH channel is assumed to be included within the measurement period.

The assumption of whether or not a non-transmission period of the HS-PDSCH channel is included within the CPICH reception quality measurement period is determined based on a total reception level and a total received power.

In one embodiment of the present invention, a communications device operable to receive parameters dependent on a reception environment from at least one reception device that is a potential target of data transmission using a shared channel and to carry out transmission of data to the reception device based on adaptive modulation control based on the parameters through the shared channel, the communications device comprises a notification device operable to notify regarding whether data is transmitted through the shared channel to none of the at least one reception devices or data is transmitted through the shared channel to any of the at least one reception device.

The data that is transmitted through the shared channel to at least one reception device, is not limited to transmission to the reception device that is the notification target.

In one embodiment of the present invention, a communications device comprises a reception device operable to receive from a transmission device notification regarding whether data is transmitted through a shared channel to none of at least one reception devices or data is transmitted through the shared channel to any of the at least one reception devices and a transmission processor operable to transmit adaptive modulation control parameters based on the notification.

The data that is transmitted through the shared channel to at any of the least one reception devices, is not limited to transmission to the reception device that is the notification target.

In one embodiment of the present invention, a radio communication system comprises a transmission device operable to transmit signal according to adaptive modulation control and a reception device operable to receive a signal from the transmission device, wherein said transmission device has a controller controlling the adaptive modulation control based on a transmission status of the signal.

The controller comprises a parameter generator operable to generate the adaptive modulation control parameters based on measurement results of the reception environment and on a reception status of a predefined channel within a period of the measurement of the reception environment.

The communications device further comprises a transmission rate generator operable to generate a transmission rate based on the generated adaptive modulation control parameters, wherein the transmission rate generated when the predefined channel is not transmitted to any of the mobile stations is a lower transmission rate than the transmission rate generated when the predefined channel is at least transmitted to the communications device within the measurement period.

The parameter generator is further operable to reflect in the parameters generated when the predefined channel is not transmitted to any of the mobile stations the measurement results when the predefined channel is at least transmitted to the communications device within the measurement period.

The measuring part is further operable to divide the measurement period into a first measurement period and a second measurement period and to combine weighted measurement results from both periods to form the measurement result.

The reception status of the predefined channel is determined according to whether or not the predefined channel was transmitted to the communications device within the measurement period.

The reception status of the predefined channel is determined based on whether or not a non-transmission period of the predefined channel is assumed to be included within the measurement period.

The assumption of whether or not a non-transmission period of the predefined channel is included within the measurement period is determined based on a total reception level and a total received power.

In one embodiment of the present invention, a communications device operable to receive parameters dependent on a reception environment from a reception device that is a potential target of a data transmission and to affect the transmission of data through a shared channel based on adaptive modulation control based on the parameter information, the communications device comprises a controller operable to perform adaptive modulation control based on the parameters and on a transmission status of data from the communications device through the shared channel.

In one embodiment of the present invention, a radio base station used in an HSDPA-compatible mobile communications system, the base station comprises a controller that carries out adaptive modulation control based on a transmission status of an HS-PDSCH and CQI information from the mobile station.

In one embodiment of the present invention, a radio base station used in a mobile communication system compatible with HSDPA, said base radio base station comprises a notification device operable to notify a mobile device of a transmission status of a HS-PDSCH and a controller operable to perform adaptive modulation control based on CQI information generated by the mobile station based on the notification.

### BRIEF DESCRIPTION OF THE DRAWINGS

FIG. 1 is a diagram showing the channel configuration of HSDPA

FIG. 2 is a diagram showing an example of a CQI table

FIG. 3 is a diagram showing a communications device (mobile station), according to the present invention.

FIG. 4 is a schematic diagram of CQI generation.

FIG. 5 is a diagram showing a wireless base station, according to the present invention.

FIG. 6 is a diagram showing a wireless base station, according to the present invention.

### DETAILED DESCRIPTION OF THE PREFERRED EMBODIMENTS

Referring to the diagrams, explanations of the embodiments of this invention are as follows.

### Description of Preferred Embodiment 1

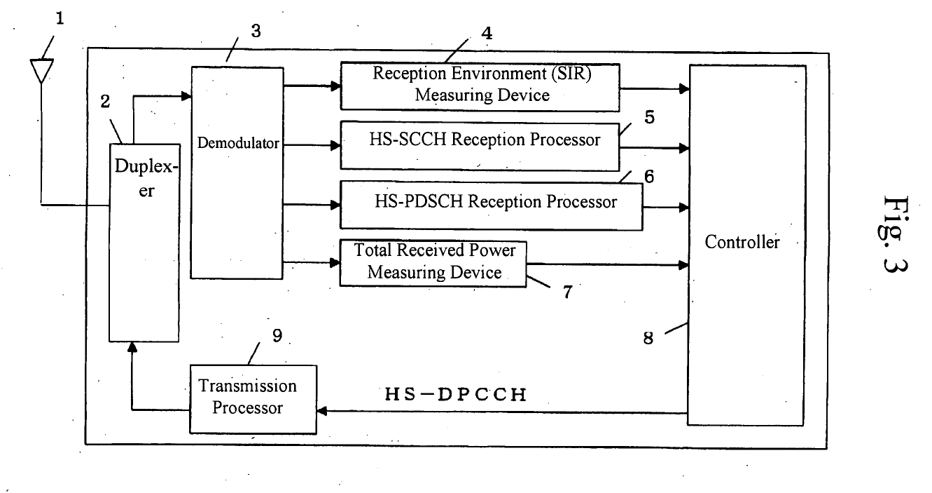

FIG. 3 shows the communications device relating to this invention. A mobile station utilized as a mobile communications system compatible with WCDMA (UMTS) using HSDPA is explained as an example of the communications device. Of course, application to communications devices used in other mobile communication systems is also possible.

In the diagram, 1 refers to the antenna; 2 refers to the duplexer; 3 refers to the demodulator; 4 refers to the reception environment (SIR) measuring device; 5 refers to the HS-SCCH reception processor; 6 refers to the HS-PDSCH reception processor; 7 refers to the total received power measuring device; 8 refers to the controller; and 9 refers to the transmission processor.

The mobile station receives the downlink channels (i.e. CPICH, P-CCPCH, HS-SCCH, HS-PDSCH, etc.) from antenna 1 and sends them to demodulator 3 through duplexer 2. Demodulator 3 executes the reception process of orthogonal detection on the received signals and sends the demodulated signals to the reception environment (SIR) measuring device 4, HS-SCCH reception processor 5, HS-PDSCH reception processor 6, and total received power measuring device 7.

Reception environment measuring device 4 measures the reception environment utilized to specify CQI information as the parameters used to control the adaptive modulation of the base station. As an example, the SIR of CPICH, a downlink signal, is measured. Obviously, other measurements for evaluating the quality of signal transmitted (broadcasted) from the base station can be adopted instead of the measurement of the SIR.

Note that the measurement of the CQI information is performed during the period from before the 4th slot to before the 1st slot of CQI transmission. There are different measuring periods. For example, measuring within 20 ms once and transmitting the same measurement results for the first to the fourth subframe repeatedly, halting the transmission of the remaining 6 subframes, measuring once in the next wireless frame, and transmitting using the same predetermined subframe can also be done.

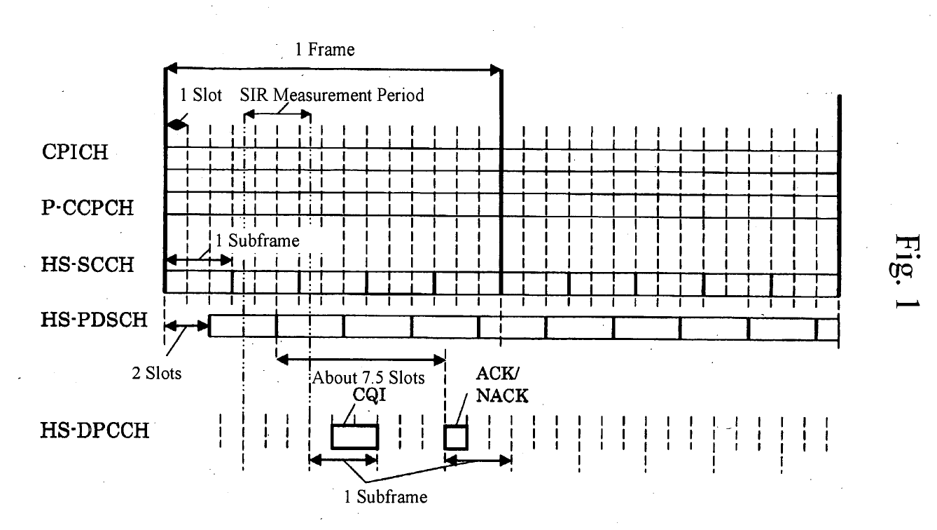

HS-SCCH reception processor 5 is a reception processor that receives the signals transmitted through HS-SCCH, as shown in FIG. 1. The HS-SCCH reception processor 5 receives each first slots of the HS-SCCH, performs demodulation and decoding for received data and determines whether there is a message addressed to the mobile station or not.

The first slot of HS-SCCH is utilized to transmit data obtained by multiplying convolution-coded Channelization Code Set information (Xccs) and Modulation Scheme information (Xms) with User Equipment identity (Xue) information, The mobile station performs reverse calculation and decoding processes with the own Xue and determines whether the message is addressed to the mobile station; If the mobile station determines that the message is addressed to the mobile station, the mobile station receives the remaining slots of HS-SCCH and attempts to receive the two-slot-delayed HS-PDSCH.

It is required for receiving HS-PDSCH that the demodulation using the despreading code(s) specified by Xccs and demodulation method specified by Xms is executed. Furthermore, after HS-SCCH's 2 slots, Transport Block Size information (Xtbs), Hybrid ARQ Process information (Xhap), Redundancy and constellation Version (Xrv), and New Data indicator (Xnd) are included. The meaning and purpose of this information are well known, therefore, the explanations will be shortened.

HS-PDSCH reception processor 6 executes the reception process when a message addressed to the mobile station is present at HS-SCCH reception processor 5. The results of demodulation and decode are output to controller 8. As previously explained, information necessary to execute the demodulation process can be obtained by receiving through HS-SCCH. Controller 8 can also confirm the actual transmission addressed to the mobile station through HS-PDSCH based on the decoding results (i.e. no CRC errors).

Total received power measuring part 7 is a device that measures the total received power. The total received power within the measurement period of the reception environment in the receiving measuring part 4 is measured and reported to controller 8. The total received power can be changed to the received level.

Furthermore, HS-SCCH reception processor 5, HS-PDSCH reception processor 6, and total received power measuring part 7 play the role to notify the reception status of the predetermined channel (HS-PDSCH) to controller 8.

Controller 8 recognizes the reception status of HS-PDSCH, based on the signals from HS-SCCH reception processor 5, HS-PDSCH reception processor 6, and total received power measuring device 7 etc., and generates CQI information as a parameter based on the recognized reception status and the measurement results from the reception environment measuring device 4, and sent CQI information to transmission processor 9. Accordingly, controller 8 also functions as a parameter generator (CQI information generator).

In addition, controller 8 demodulates the data received via HS-PDSCH, and performs a CRC check to determine whether the data can be received. If there is no CRC error, an ACK signal is generated, and if there is a CRC error, a NACK signal is generated, and sent to transmission processor 9.

Transmission processor 9 transmits CQI information, ACK, and NACK signals from the controller through the predetermined slots of HS-DPCCH.

The above was an explanation of each component's operation, as shown in FIG. 3. Furthermore, the base station performs transmitting process using the transmission (modulation) methods corresponding to CQI information received through HS-DPCCH. When the ACK signal is received, the next new data is transmitted. The transmission data is retransmitted if the NACK signal is received or the ACK signal is not received within the predetermined time after transmission of HS-PDSCH.

Method of Generating CQI Information 1

Explanation of the method to generate CQI information, the parameters transmitted by the mobile station to the base station, is as follows.

In this example, controller 8 determines whether HS-PDSCH was transmitted to the mobile station device within the SIR measurement period of the reception environment measuring device 4. If controller 8 determines that the transmission to the mobile station is executed, controller 8 controls to select CQI information corresponding to lower transmitting speed than transmitting speed in case that controller 8 determines that the transmission to the mobile station is not executed.

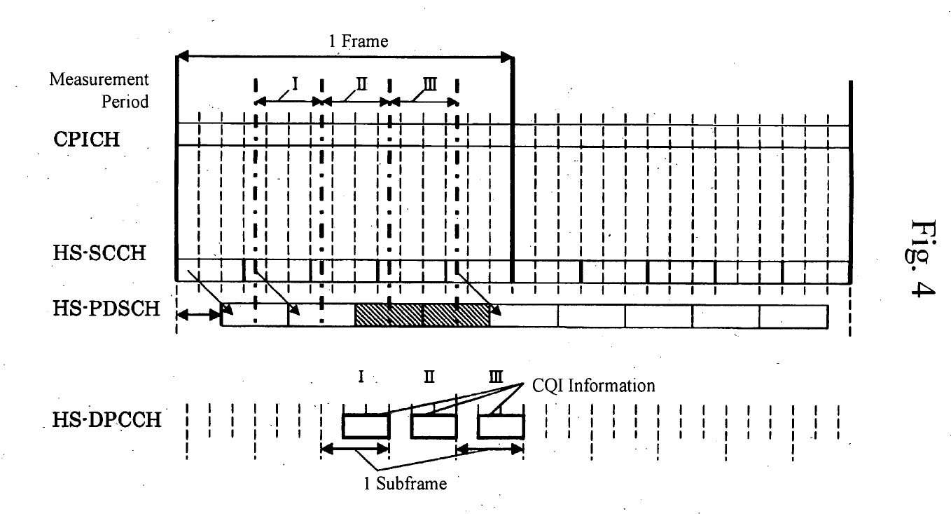

As shown in FIG. 4, the mobile station measures SIR of CPICH in measurement period I, II, and III, as an example, using the reception environment measuring device 4.

As indicated by the arrows in the diagram, each of the first slots of the first and second subframes of HS-SCCH provide advanced notification that data will be transmitted through HS-PDSCH, addressed to this mobile station.

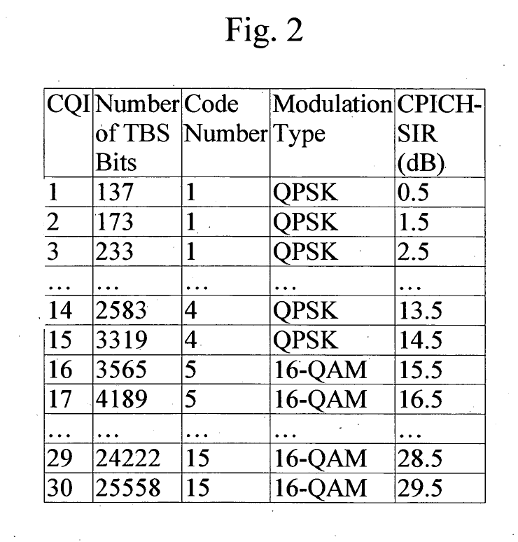

The mobile station is then able to recognize the transmissions addressed to at least the mobile station for the first and second subframes of HS-PDSCH by HS-SCCH reception processor 5. Accordingly, the mobile station selects CQI information corresponding to the reception environment measured during the measurement period I when HS-PDSCH is transmitted, by referring the table in FIG. 2 and sends the selected CQI information to transmission processor 9 as CQI information I.

However, HS-SCCH reception processor 5 may detect no transmission of advance notice of HS-PDSCH for the third subframe of HS-SCCH.

In this case, it is possible that data has not been transmitted to any of the mobile station for the third subframe of HS-PDSCH. Accordingly, the reception environment measured during measurement period II includes this type of period and it may be recognized that the results, by chance, were measured under a favorable environment without the transmission of HS-PDSCH. Therefore, controller 8 decreases the CQI value (select parameters to decrease transmission speed by adaptive modulation).

The first method to decrease CQI is to select a smaller CQI than CQI corresponding to measured SIR by referring to the table of CQI (described in FIG. 2) or select CQI information corresponding'to measured SIR by referring another table of CQI. In another table of CQI, each CQI information is related to each measured SIR, wherein each CQI in another table is smaller than each CQI in the table (described in. FIG. 2) for same measured SIR.

The second method to decrease the value of CQI is to decrease the measurement value of the SIR itself with a predetermined value and to refer to a table similar to FIG. 2.

As explained in the above, CQI information II corresponding to measurement period II is transmitted to the base station after correcting it to a smaller value.

Furthermore, as there is no advanced transmission notification of HS-PDSCH to the mobile station for the forth subframe of HS-SCCH, there still may be a possibility that measurement period III is a non-transmission (the reception environment is especially favorable) period of the-HS-PDSCH to the mobile station. Therefore, the CQI information is corrected to a small value, similar to the CQI generated by measurement period II, and the corrected CQI information is transmitted to the base station.

The above was an explanation of a first method of generating CQI information. An explanation of a second method of generating CQI information is as follows.

Method of Generating CQI Information II

Previously measured reception environment and CQI information can be used in other methods of generating CQI information.

For example, controller 8 can recognize whether HS-PDSCH is-transmitted to the mobile station during measurement period I. Controller 8 generates CQI corresponding to measured SIR, referring to the table in FIG. 2, and sends it to transmission processor 9. Controller 8 then records the measured SIR or the generated CQI information in a memory (not shown). The generated CQI information may be flagged in the CQI table.

As previously explained, HS-SCCH reception processor 5 detects that the period of HS-PDSCH's non-transmission to the mobile station is included in measurement period II, therefore, controller 8 reads the recorded (flagged) and previously transmitted CQI information and sends it to transmission processor 9 for transmission of CQI corresponding to measurement period II.

Note that, if the recorded information is the measured SIR, the measured SIR is read from the memory and corresponding CQI information is specified, using the table in FIG. 2. Similarly, the specified CQI information can be sent to transmission processor 9.

Even during measurement period III, the similarly generated CQI information based on the measured SIR during measurement period I is sent to transmission processor 9.

As previously explained, reception in response to the adaptive modulation is smooth by utilizing the immediately preceding CQI information, compatible with the results measured during the period of HS-PDSCH's transmission to the local device.

Furthermore, as the period of HS-PDSCH's transmission to the mobile station is included in measurement period II, the measurement results of measurement period II are utilized to generate and transmit CQI information as CQI information corresponding to measurement period II. CQI information corresponding to measurement results in measurement period I or II can be transmitted as CQI information corresponding to measurement period III.

In this manner, generated CQI information, based on at least the measurement results during the period of HS-PDSCH's transmission to the mobile device, can be applied as CQI information corresponding to the period when HS-PDSCH can be not transmitted to any of the mobile stations.

In the above example the measurement results during the period when HS-PDSCH is transmitted to at least the mobile station is reflected to the generation of the CQI information corresponding to the period when HS-PDSCH can be not transmitted to any of the mobile stations.

In addition to applying the previously generated CQI information as the current CQI information, other methods of reflection include taking the average of both CQI information and utilizing the CQI after combining the attached weight.

In addition, controller 8 detects changes in reception status and can erase (not use) the recorded CQI information when recording the previously generated CQI (SIR) information.

For example, if a long time has elapsed since the recording of CQI information, the propagation environment is assumed to have changed and the reliability of the recorded CQI information decreases. It is preferred to detect the lapse of a predetermined amount of time from the previous CQI generation as a timeout by a timer. In the event of a timeout, the recorded CQI information does not have to be utilized (erased). It is desirable to transmit the CQI information corresponding to the measured SIR in the most recent measurement period.

If a searcher, not drawn in figures, included in reception environment measuring device 4 detects receiving timings of pilot signals transmitted via multi-path, it is possible not to utilize, or erase, the recorded CQI information in case that changes are detected about total number of paths having predetermined correlation value or distribution value of delay profile generated in the searcher exceeds the predetermined value.

In this example, reception status of HS-PDSCH is evaluated utilizing HS-SCCH as the advanced transmission notification of HS-PDSCH, however, the reception status of HS-PDSCH is evaluated by the reception processing results (i.e. CRC check results) for the HS-PDSCH reception processor 6. However, as the entire subframe of HS-PDSCH, where the later part of measurement period I and transmission timing of the subframe of HS-PDSCH overlap, has not been received when transmitting the CQI information I, therefore, only the reception status of HS-PDSCH during the first half of the measurement period can be evaluated. However, the generation of an error is suppressed when the reception status of HS-PDSCH is not evaluated at all.

Other Methods to Evaluate the Reception status of HS-PDSCH

In the previous example, the processing results of HS-SCCH reception processor 5 and HS-PDSCH reception processor 6 were utilized to evaluate the reception status of HS-PDSCH.

Explanation of the evaluation method utilizing measurement results of the total received power measuring part 7 is as follows.

The total received power measuring part 7 calculates, at the least, the measurement results of the total received power for each of the reception environment measurement periods (I, II, III) and determines whether the total received power is smaller than the predetermined standard. If the value is determined as being smaller than the predetermined standard, the possibility that HS-PDSCH is not being transmitted is high. This is because HS-PDSCH is a high-speed downlink channel and the transmission power of HS-PDSCH is sufficiently larger than that of CPICH

Accordingly, if the total received power is below the predetermined standard, controller 8 either corrects the CQI value to a small value or records the CQI value corresponding to the period where the total received power exceeded the predetermined standard (or data may be transmitted via HS-PDSCH to the mobile station according to HS-SCCH) because the HS-PDSCH is considered as not being transmitted to the mobile station and other mobile stations. Then controller 8 transmits CQI value which is immediately before recorded.

In addition, the total received power measuring device 7 measures the total received power before and after the start of each subframe of HS-PDSCH and judges that the status of HS-PDSCH is changed to transmitting status based on the total received power before and after the start of each subframe of HS-PDSCH. If the broadly increase of total received power is detected, corresponding measured value is used for read of CQI information from the table, drawn in FIG. 2, because the corresponding measured value is valid and the read CQI is sent to transmission processor 9. On the other hand, if the total received power broadly decreases, CQI information, during the corresponding measurement period, is corrected because the status of HS-PDSSCH is determined to have changed to a transmission halt status from a transmitting status.

### Description of Preferred Embodiment 2

In a second embodiment, by devising the measurement period of the reception environment, the reception status of HSPDSCH is taken into consideration for generation of parameters.

As shown in FIG. 1, portions of HS-PDSCH's two subframes are included in the measurement period. A portion of one of the subframes corresponds to the first half of the measurement period and a portion of the other subframe corresponds to the latter half of the measurement period.

In this practical example, SIR measuring device 4 defines the measurement period's first half as the first period and the latter half as the second period. Note that the first and second periods can be set by the following method. In first method the first and second period correspond to exactly half of one subframe each respectively. In second method the first and second periods are duplicated at a subframe's middle portion. In third method the first and second periods have an opening in the middle of one subframe.

When these items are defined, the reception environment measuring device 4 does not average the SIR for the entire measurement period but calculates the SIR for the first and second period separately. Weights are multiplied with each of the calculated SIR and combined and then sent to controller 8.

The weights are selected to ensure that the smaller SIR measurement value has more influence over the larger SIR measurement value. For example, weight of SIR value (small): weight of SIR value (large)=0.8: 0.2 or 1:0 and are combined.

Controller 8 specifies CQI information, referring to the CQI table in FIG. 2, based on the SIR after it is weighted and combined. Then the specified CQI information is transmitted by the transmission processor 9.

The above was an explanation of the second embodiment. If one of the measured SIR is not relatively favorable, it can be assumed that the SIR is measured during the transmission of HS-PDSCH. Accordingly controller 8 can perform generation of parameters based on the reception status of HS-PDSCH by relatively increasing the influence of the one of the measured SIR.

### Description of Preferred Embodiment 3

In the third embodiment, the radio base station notifies the mobile station that data will not be transmitted to any of the mobile stations through HS-PDSCH or that data will be transmitted to any of the mobile stations through HS-PDSCH, not limited only to notified mobile stations.

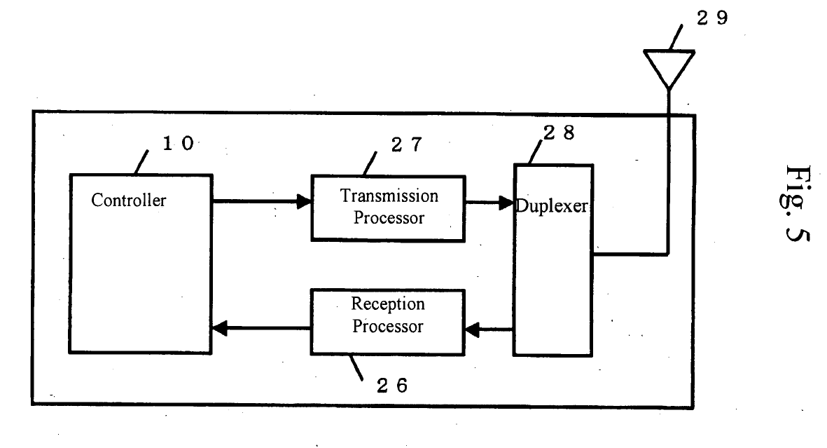

FIG. 5 shows a block diagram of the radio base station as the communications device (transmitting device).

The radio base station in the diagram has a controller 10, a reception processor 26, a transmission processor 27, a duplexer 28, and an antenna 29.

Controller 10 controls the various blocks in the radio base station and processes the reception data from the reception processor 26. In addition, the controller 10 has a function to send transmission data to transmission processor 27.

Duplexer 28 is utilized when using common antenna 29.

Reception processor 26 executes the reception process for the transmitted signals through the uplink channel, as shown in FIG. 1. Transmission processor 27 executes the transmitting process for the transmitted signals through the downlink channel.

In this embodiment, controller 10 sends notification data to transmission processor 27 for notifying the mobile station that data will not be transmitted to any of the mobile stations through HS-PDSCH (first status) or that data will be transmitted to at least one of the mobile stations through HS-PDSCH (second status). The notification data is transmitted to the mobile station via the downlink channel under the control of controller 10.

Preferably, notifications will be transmitted to several mobile stations through P-CCPCH. Transmission before the second or first slots of HS-PDSCH's transmission, as in FIG. 1, would be better. If the mobile stations can use the notification data for generation of CQI, other slots can be used for transmission.

On the other hand, the mobile station receives the corresponding notification by the P-CCPCH reception processor, not illustrated in FIG. 3, and corrects the SIR measurement results of reception environment measuring device 4, based on this notification.

In other words, if controller 8 detects the first status according to the notification, the SIR measurement value is corrected to a smaller value. After the correction, the controller 8 specifies CQI based on the corrected SIR by referring to the table in FIG. 2, and controls the transmission processor 9 to transmit the specified CQI. Obviously, the controller 8 can specify CQI based on both a table corresponding to status and measured SIR to correct CQI as a small CQI.

This notification can be used for assumption of receiving status about HS-PDSCH in the previous example. For operations aside from assuming the reception status, the previous practical examples of CQI correction operation should be followed.

The reception status of HS-PDSCH can be evaluated with great accuracy by following the above.

### Description of Preferred Embodiment 4

In this exemplary embodiment, the radio base station itself adjusts the modulation controls, taking into consideration the reception status of HS-PDSCH. The controller of the radio base station understands whether to transmit each of HS-PDSCH's subframes. Accordingly the controller corrects the received CQI information according to whether the CQI received from the mobile station was generated based on the reception environment measured during the transmission period of HS-PDSCH (first period) or whether it was generated based on the reception environment measured during the non-transmission period of HS-PDSCH (second period), and controls adaptive modulation and coding according to the CQI information after the correction.

Specifically, the controller 10 in FIG. 5 determines whether the CQI information received by reception processor 26 is based on the received SIR measured during the first period or based on the received SIR measured during the second period. As shown in FIG. 1, it is clear that CQI information is based on the measured SIR in a period having a predetermined length, wherein the start timing of the period is before the transmission timing of CQI information by a predetermined slots number (for example the period stats before the transmission timing of CQI by four slots and ends before the transmission timing of CQI by one slot). Therefore, controller 10 checks the history of HS-PDSCH's transmission status during this predetermined period (transmission record of HS-PDSCH is recorded).

When controller 10 determines, from the history, that the received CQI is based on measurement results measured during the first period, the adaptive modulation is conducted according to the CQI. On the other hand, if the received CQI is determined as being based on the measurement results measured during the second period, the CQI is corrected to a CQI smaller than the received CQI and the adaptive modulation is conducted according to the CQI after corrections (in this case, transmission speed is controlled to be even slower that if the CQI received from the mobile station is used as is). Obviously, controller 10 also sets data transmitted to the mobile station via HS-SCCH as data corresponding to the adaptive modulation control based on the CQI after corrections, and set data is transmitted from transmission processor 27.

Furthermore, ideally, controller 10 records the most recent estimated CQI (first CQI) if the CQI is based on measurement results measured from the first period and the most recent estimated CQI (second CQI) if the CQI is based on the measurement results measured from the second period individually, and for each mobile station.

And, when HS-PDSCH is transmitted to the corresponding mobile stations, adaptive modulation control is carried out using the CQI corresponding to the transmission status period of HS-PDSCH closest to the status of the transmitting HS-PDSCH, among the first CQI and the second CQI. In other words, if the transmitting HS-PDSCH is addressed only to one mobile station, the second CQI is applied. If the transmitting HS-PDSCH is addressed to two or more mobile stations, the first CQI may also be applied.

It is preferred that the reception status of HS-PDSCH is defined with over 2 or 3 types and is not limited to the first and second CQI. By recording the corresponding CQI value for each status, the adaptive modulation can be controlled with further accuracy.

The following can be given as representative examples of status types: transmission of HS-PDSCH to only its mobile station; transmission of HS-PDSCH to its mobile station and N (positive integer) other units; level M within the N ranking, of total transmitting power (M is over and N is under); level M within the N ranking of traffic of other dedicated channel for downlink 1 or uplink (M is over and N is under); and level M within the N ranking of traffic of other shared channel for downlink or uplink(M is over and N is under), etc.

Various types of embodiment were explained in the above, but all of the practical examples had in common the point that, in a radio communications system provided with a transmission device that carries out adaptive modulation control and a reception device that receives signals from the transmission device, adaptive modulation control is carried out based on the transmission status of a signal transmitted by the adaptive modulation control of a transmission device.

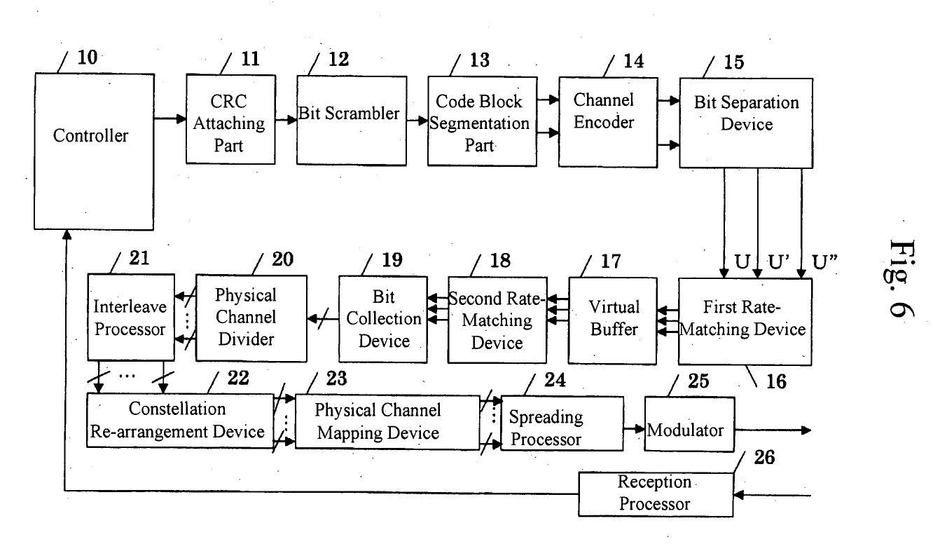

Finally, in FIG. 6 the base station configuration is explained, using a detailed drawing. Furthermore, the transmission processor components of HS-PDSCH (11-25) of transmission processor 27 and reception processor 26 are explained in detail.

In the diagram, controller 10 outputs the transmission data (data transmitted within one subframe) transmitted through HS-PDSCH in sequence and indicates the controller controlling the various components (11-26). As HS-PDSCH is a shared channel, it is permitted that the transmission data output in sequence be each addressed to a different mobile station.

CRC attaching part 11 executes CRC calculations regarding the transmission data input in sequence (data transmitting within the same wireless frame) and adds the CRC calculation results to the tail end of this transmission data. Bit scrambler 12 is the unit that, for the transmission data, to the tail of which the CRC calculation results have been added, scrambles the bit units of the transmission data added as CRC calculation results and randomizes the transmission data.

Code block segmentation part 13 divides (e.g. into two equal parts) the transmission data when a predetermined data length is exceeded, to avoid increasing the calculations of the decoder on the receiving side, since, in the channel encoding carried out next, the length of the data is made the subject of encoding. The diagram shows the output when the input data exceeds the predetermined data length and shows the output after it has been divided into two equal parts (divided into the first and second data blocks). Needless to say, examples of divisions other than two can be produced, but there are also examples of data with different data lengths.

Channel Encoder 14 separately executes error-correcting coding processing for the various divided data. Furthermore, it is desirable that the above-mentioned turbo encoder is utilized as channel encoder 14 and a turbo coder, for example, is used here.

Accordingly, the first output, as previously explained, for the first block includes: the important systematic bit (U), the same as the encoding target data; the first redundant (parity) bit (U′), resulting from the convolution coding of the systematic bit (U); and the second redundant (parity) bit (U″), resulting from the same convolution coding after an interleave process is executed on the systematic bit. Similarly, the second output for the second block includes: the systematic bit (U) for the second block, the first redundant bit (U′), and the second redundant bit (U″).

Bit separation device 15 divides and outputs each of the first and second blocks serial-input from channel encoder 14 (turbo encoder), the system bit (U), the first redundant bit (U′), and the second redundant bit (U″). Furthermore, as the second block is identical, only the output corresponding to the first block is illustrated.

First rate-matching part 16 executes the rate matching process, such as a puncture process (thinning out) on the input data so that the input data (when the data is divided into several blocks, all of the data in the divided blocks) to make it fit into the predetermined area of the subsequent virtual buffer 17.

First rate matching part 16 executes rate matching by the first pattern during initial transmission or when retransmission is not specified. The quantity of data after this rate matching should be established at the same (or less) capacity as the memory (memory 31, mentioned later) to implement H-ARQ by the mobile station receiving data. For example, the information regarding the performance of mobile stations while the mobile station is calling is transmitted to the base station. Controller 10 of the base station recognizes the memory capacity of the mobile station's H-ARQ, based on the information regarding the received performance. The first rate-matching device notifies and establishes the recognized capacity to the virtual buffer 17.

Virtual buffer 17 stores the data processed by the first rate-matching device 16 in the area established in response to the reception processing capacity of the transmission targeted mobile station by controller 10.

Second rate-matching part 18 adjusts data to a length storable in the 1 subframe specified by the controller 10. Controller 10 executes the puncture (thinning out) and repetitious processes (repeating) to adjust the input data to the specified length.

Furthermore, since, in HS-PDSCH, as the parameters of the modulation method, spreading rate, and code numbers (channel numbers) can be changed, the received number of bits is not constant even if the subframes are the same length. Controller 10 notifies the second rate-matching device of the number of bits corresponding to the parameters as the data length that can be received by one subframe. In addition, controller 10 notifies the second rate-matching part 18 of the pattern after conversion, for instance when the rate matching pattern changes every retransmission.

Bit collection device 19 arranges the data from the second rate-matching device 18 into multiple bit strings. In other words, by arranging the data of the first and second blocks by a predetermined bit arranging method, multiple bit sequences are output indicating the signal points on the various phase planes.

Furthermore, in this example, the bit sequence is configured from 4 bits to utilize the 16 QAM modulation method. Obviously, there are other examples of multi-bit modulation methods (i.e. 8-PSK, etc.)

Physical channel divider 20 divides and outputs the bit string to the system with the same number as the spreading code (code number) number indicated by controller 10. In other words, if the code number of the transmission parameter is N, this refers to the physical channel segmentation device which distributes and outputs into the 1-N system in the input order of the bit sequence.

Interleaving part 21 executes the interleaving process and outputs the various bit sequences of the N system.

Constellation re-arrangement device 22 rearranges bits within the input bit sequence for 16 QAM. For example, at the time of initial transmission, the various input bit sequences pass through and output and the bits are rearranged during the previously explained H-ARQ retransmission. As bit rearrangements, for instance, the top and bottom bits can be exchanged, etc., and for multiple sequences, it is preferable that bits be interchanged according to the same rule. It is preferred that the bit sequences are rearranged by interchanging the upper and lower bits. Furthermore, they may pass in that state during retransmission.

Physical channel mapping part 23 sorts the latter-part N-system bit sequence into the spreading part corresponding to the latter-part spreading processor.

Spreading part 24 executes the spreading process and outputs according to the different spreading codes. The corresponding voltage values of I and Q are output according to each of the bit sequences of the N system of the multiple spreading parts.

Modulator 25 combines the various signals spread by spreading processor 24. Accordingly, amplitude phase modulation is carried out in the 16 QAM modulation mode, and after the frequency is converted to a radio signal, the signal is output to the antenna and the modulating part makes the radio signal transmittable.

Receiver 26 receives signals from the mobile station through HS-DPCCH, and this device sends ACK signals and NACK signals, and CQI information to controller 10.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A communications device for transmitting parameters used for adaptive modulation control to a transmitting device that executes adaptive modulation control, comprising:
a measuring device operable to measure the reception environment; and
a parameter generator operable to generate the parameters based on measurement results of the reception environment and on a reception status of a predefined channel within a period of the measurement of the reception environment.

2. The communications device of claim 1, wherein the parameter is set as different parameters for same measured reception environment according to the reception status, wherein the transmission rate corresponding to the parameters for the reception status indicating that the predetermined channel is transmitted at least to the communication device is lower than the transmission rate corresponding to the parameters for the reception status indicating that the predetermined channel is not transmitted to any of communication devices.

3. The communications device of claim 1, wherein the parameter generator is further operable to reflect in the parameters generated when the predefined channel is not transmitted to any of the mobile stations the measurement results when the predefined channel is at least transmitted to the communications device within the measurement period.

4. The communications device of claim 1, wherein the measuring part is further operable to divide the measurement period into a first measurement period and a second measurement period and the parameter generator combines weighted measurement results from both periods to form the measurement result.

5. The communications device of claim 1, wherein the reception status of the predefined channel is determined according to whether or not the predefined channel was transmitted to the communications device within the measurement period.

6. The communications device of claim 1, wherein the reception status of the predefined channel is determined based on whether or not a non-transmission period of the predefined channel is assumed to be included within the measurement period.

7. The communications device of claim 6, wherein the assumption of whether or not a non-transmission period of the predefined channel is included within the measurement period is determined based on a total reception level or a total received power.

8. A mobile station used in a mobile communications system compatible with HSDPA, comprising:
a CQI information generator operable to generate CQI information to be transmitted to a base station based on an HS-PDSCH reception status during a CPICH reception quality measurement period.

9. The mobile station of claim 8, further comprising:
a transmission rate generator operable to generate a transmission rate based on the generated CQI information, wherein the transmission rate generated when the HS-PDSCH is not transmitted to any of the mobile stations is a lower transmission rate than the transmission rate generated when the HS-PDSCH is at least transmitted to the mobile station within the CPICH reception quality measurement period.

10. The mobile station of claim 8, wherein the CQI information generator is further operable to reflect in the CQI information generated when the HS-PDSCH channel is not transmitted to any of the mobile stations the measurement results when the HS-PDSCH channel is at least transmitted to the mobile station within the CPICH reception quality measurement period.

11. The mobile station of claim 8, further comprising a measuring part operable to divide the CPICH reception quality measurement period into a first measurement period and a second measurement period and to combine weighted measurement results from both periods to form the CPICH reception quality measurement result.

12. The mobile station of claim 8, wherein the HS-PDSCH reception status is determined according to whether or not the HS-PDSCH channel was transmitted to the mobile station within the measurement period.

13. The mobile station of claim 8, wherein the HS-PDSCH reception status is determined based on whether or not a non-transmission period of the HS-PDSCH channel is assumed to be included within the measurement period.

14. The mobile station of claim 13, wherein the assumption of whether or not a non-transmission period of the HS-PDSCH channel is included within the CPICH reception quality measurement period is determined based on a total reception level and a total received power.

15. A communications device operable to receive parameters dependent on a reception environment from at least one reception device that is a potential target of data transmission using a shared channel and to carry out transmission of data to the reception device based on an adaptive modulation control based on the parameters through the shared channel, the communications device comprising:
a notification device operable to notify regarding whether data is transmitted through the shared channel to none of the at least one reception devices or data is transmitted through the shared channel to any of the at least one reception device.

16. The communications device of claim 15, wherein the data that is transmitted through the shared channel to at least one reception device, is not limited to transmission to the reception device that is the notification target.

17. A communications device comprising:
a reception device operable to receive from a transmission device notification regarding whether data is transmitted through a shared channel to none of reception devices or data is transmitted through the shared channel to any of the at least one reception devices; and
a transmission processor operable to transmit adaptive modulation control meters based on the notification.

18. The communications device of claim 17, wherein the notification is transmitted through a common channel.

19. In a radio communications system comprising:
a transmission device operable to transmit signal according to adaptive modulation control, and
a reception device operable to receive a signal from the transmission device, wherein
said transmission device has a controller controlling the adaptive modulation control based on a transmission status of the signal.

20. The communications device of claim 19, wherein the controller comprises:
a parameter generator operable to generate the adaptive modulation control parameters based on measurement results of the reception environment and on a reception status of a predefined channel within a period of the measurement of the reception environment.

21. The communications device of claim 20, further comprising:
a transmission rate generator operable to generate a transmission rate based on the generated adaptive modulation control parameters, wherein the transmission rate generated when the predefined channel is not transmitted to any of the mobile stations is a lower transmission rate than the transmission rate generated when the predefined channel is at least transmitted to the communications device within the measurement period.

22. The communications device of claim 20, wherein the parameter generator is further operable to reflect in the parameters generated when the predefined channel is not transmitted to any of the mobile stations the measurement results when the predefined channel is at least transmitted to the communications device within the measurement period.

23. The communications device of claim 20, wherein the measuring part is further operable to divide the measurement period into a first measurement period and a second measurement period and to combine weighted measurement results from both periods to form the measurement result.

24. The communications device of claim 20, wherein the reception status of the predefined channel is determined according to whether or not the predefined channel was transmitted to the communications device within the measurement period.

25. The communications device of claim 20, wherein the reception status of the predefined channel is determined based on whether or not a non-transmission period of the predefined channel is assumed to be included within the measurement period.

26. The communications device of claim 25, wherein the assumption of whether or not a non-transmission period of the predefined channel is included within the measurement period is determined based on a total reception level and a total received power.

27. A communications device operable to receive parameters dependent on a reception environment from a reception device that is a potential target of a data transmission and to affect the transmission of data through a shared channel based on adaptive modulation control based on the parameter information, the communications device comprising:
a controller operable to perform adaptive modulation control based on the parameters and on a transmission status of data from the communications device through the shared channel.

28. A radio base station used in an HSDPA-compatible mobile communications system, said base station comprising:
a controller that carries out adaptive modulation control based on a transmission status of a HS-PDSCH and CQI information from the mobile station.

29. A radio base station used in a mobile communication system compatible with HSDPA, said radio base station comprising:
a notification device operable to notify a mobile device of a transmission status of a HS-PDSCH; and
a controller operable to perform adaptive modulation control based on CQI information generated by the mobile station based on the notification.
